(19) United States
(12) Patent Application Publication
(10) Pub. No.: US 2019/0287391 A1
(43) Pub. Date: Sep. 19, 2019

(54) TRAFFIC DEMAND PREDICTION SYSTEM AND TRAFFIC DEMAND PREDICTION APPARATUS

(71) Applicant: HITACHI, LTD., Tokyo (JP)

(72) Inventors: Ryo OZAWA, Tokyo (JP); Akihiko HYODO, Tokyo (JP); Yasuo SUGURE, Tokyo (JP)

(73) Assignee: HITACHI, LTD., Tokyo (JP)

(21) Appl. No.: 16/299,390

(22) Filed: Mar. 12, 2019

(30) Foreign Application Priority Data
Mar. 15, 2018 (JP) 2018-048609

(51) Int. Cl. G08G 1/01

(52) U.S. Cl. CPC G08G 1/0129

(57) ABSTRACT

Provided is a traffic demand prediction system for predicting traffic demand when a new event as a prediction target event occurs, the system including: a past event data base including information indicating a site of a past event which is an event held in the past and traffic demand data of the past event; a retrieving unit retrieving a past event held in a site coinciding with a site of the new event from the past event data base as a similar event; and a correcting unit reflecting the difference between the similar event retrieved by the retrieving unit and the new event to traffic demand data of the similar event.

### BACKGROUND OF THE INVENTION

### 1. Field of the Invention

The present invention relates to a traffic demand prediction system and a traffic demand prediction apparatus, and is, for example, suitable for application to a traffic demand prediction system and a traffic demand prediction apparatus for predicting traffic demand when an event occurs.

### 2. Description of Related Art

In modern times where urbanization progresses, traffic congestion due to an increase of traffic demand has caused serious losses in terms of time and energy. It is important to predict realistic traffic flow with high accuracy in order to make measures to reduce the congestion. In particular, unexpected loss due to congestion caused by occurrence of unusual events is a social problem to be solved. As traffic flow simulation technique in the related art, there is a method attracting attentions in which the traffic demand on each road is estimated by the macro traffic flow simulation based on traffic demand data in a wide area to reproduce the vehicle driving situation by the micro traffic flow simulation from the estimated result. To predict correct traffic demand is a technical problem to be solved in this method.

In order to simulate the traffic flow with high accuracy, there is disclosed a system for predicting the traffic demand using traffic volume statistical data and online traffic flow information (refer to JP-A-2003-272083). In the system described in JP-A-2003-272083, the OD traffic volume is corrected using the difference between traffic volume data of static OD (Origin-Destination) data and traffic volume data from the online information gathered by devices.

In the system described in JP-A-2003-272083, it is possible to predict daily traffic demand from the traffic volume statistical data, but it is not possible to estimate traffic demand when unusual events occur.

### SUMMARY OF THE INVENTION

The present invention has been made in consideration of the above-described point, and is to suggest a traffic demand prediction system and a traffic demand prediction apparatus capable of predicting traffic demand when an event occurs.

For solving the above problem, according to the present invention, a demand prediction system includes: a past event data base including information indicating a site of a past event which is an event held in the past and traffic demand data of the past event; a retrieving unit retrieving a past event held in a site coinciding with a site of the new event from the past event data base as a similar event; and a correcting unit reflecting the difference between the similar event retrieved by the retrieving unit and the new event to traffic demand data of the similar event.

Further, in the present invention, a traffic demand prediction apparatus for predicting traffic demand when a new event as a prediction target event occurs, the apparatus includes: a past event data base including information indicating a site of a past event which is an event held in the past and traffic demand data of the past event; a retrieving unit retrieving a past event held in a site coinciding with a site of the new event from the past event data base as a similar event; and a correcting unit reflecting the difference between the similar event retrieved by the retrieving unit and the new event to traffic demand data of the similar event.

According to the above configurations, the traffic demand data of the similar event is corrected based on the difference between the similar event and the new event, so that it is possible to predict the traffic demand when the new event occurs.

According to the present invention, it is possible to predict traffic demand when a new event occurs.

### BRIEF DESCRIPTION OF THE DRAWINGS

FIG. 1 is a diagram illustrating a configuration example of a traffic demand prediction system according to a first embodiment;

FIG. 2 is a diagram illustrating a configuration example of a new event traffic demand predicting unit according to the first embodiment;

FIG. 3 is a diagram illustrating hardware resources of a simulator according to the first embodiment;

FIG. 4 is a diagram illustrating an example of new event information according to the first embodiment;

FIG. 5 is a diagram illustrating an example of a data structure of a past event data base according to the first embodiment;

FIG. 6 is a diagram illustrating an example of traffic demand data of a past event according to the first embodiment;

FIG. 7 is a diagram illustrating an example of a data structure of an action pattern data base according to the first embodiment;

FIG. 8 is a diagram illustrating an example of a flowchart of retrieving processing according to the first embodiment; and

FIG. 9 is a diagram illustrating an example of a flowchart of correction processing according to the first embodiment.

### DESCRIPTION OF EMBODIMENTS

An embodiment of the present invention will be described with reference to the following drawings.

### (1) First Embodiment

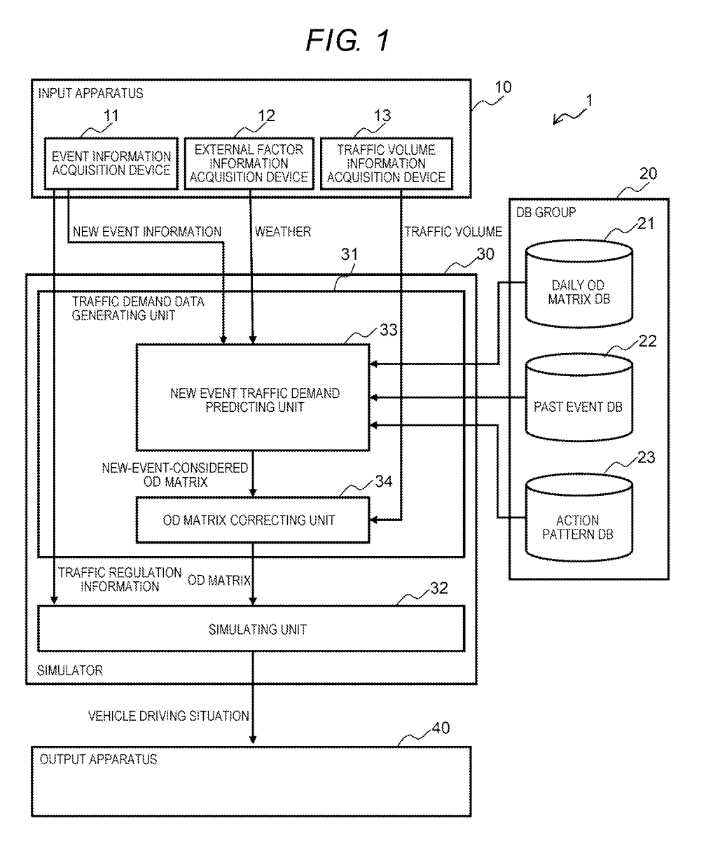

In FIG. 1, reference numeral 1 indicates a traffic demand prediction system according to a first embodiment as a whole. The traffic demand prediction system 1 is a system capable of predicting traffic demand when a scheduled event (new event), which is a prediction target of the traffic demand, occurs. The traffic demand prediction system 1 includes an input apparatus 10 which acquires various types of information to be input (transmitted) to a simulator 30, a DB (data base) group 20 which stores various types of information, the simulator 30 which reproduces a traffic flow in a virtual environment based on the information from the input apparatus 10 and the information stored in the DB group 20, and an output apparatus 40 which outputs the simulation result by the simulator 30.

The input apparatus 10 includes an event information acquisition device 11 which receives and delivers information (new event information) on a new event, an external factor information acquisition device 12 which receives and delivers information (external factor information) on external factors unrelated to the new event such as the weather and the like, and an information acquisition device 13 which receives and delivers information (traffic volume information) indicating an online traffic volume.

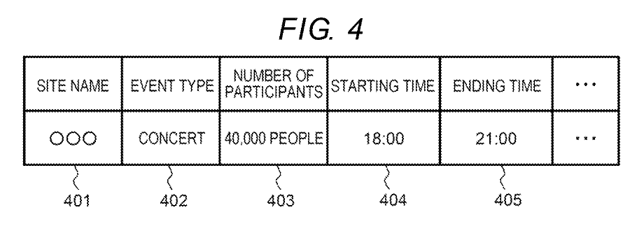

The event information acquisition device 11 acquires new event information. The new event information includes one or a plurality of pieces of information among a site name, a type, the number of participants, a starting time, and an ending time of the new event, and is acquired through an input by a user of the event information acquisition device 11. The details of the new event information will be described with reference to FIG. 4 below.

The external factor information acquisition device 12 acquires external factors unrelated to the new event such as the weather and the like. The external factor information acquisition device 12 can acquire external factors through various methods. The external factor information acquisition device 12 collects, for example, information on the weather from a web site of the meteorological agency or the like.

The traffic volume information acquisition device 13 acquires, for example, a vehicle passing amount on a predetermined road (for example, a road installed with a sensor in advance) at a certain time interval in association with the positional information on the road online.

The DB group 20 includes a daily OD matrix DB 21, a past event DB 22, and an action pattern DB 23.

In the daily OD matrix DB 21, daily OD matrixes are stored. The OD matrix is traffic demand data expressed by collecting the number of moving vehicles in association with the departure point (origin), the end point (destination), and the departure time. Basically, the OD matrix is handled in a table data format in which the origin is divided for each row and the destination is divided for each column to express the moving amount in a matrix. The table data format is not limited as long as the same data contents are contained.

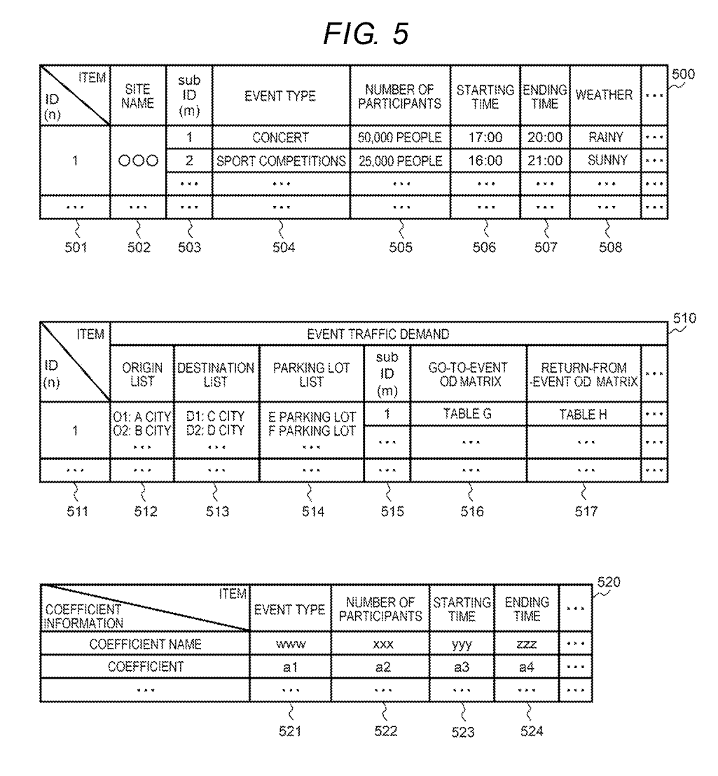

In the past event DB 22, information on the past event indicating an event held in the past is stored. For example, information indicating a past event site and traffic demand data of the past event are stored in the past event DB 22. In addition, the past event DB 22 stores, for example, one or a plurality of pieces of information among the type of the past event, the number of participants of the past event, the starting time of the past event, and the ending time of the past event. The details of the past event DB 22 will be described with reference to FIG. 5.

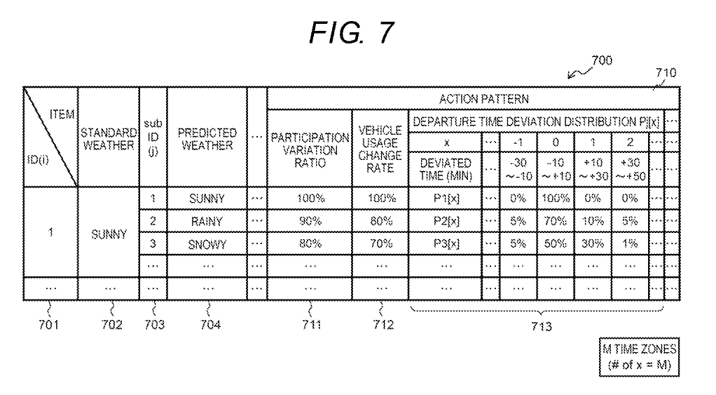

In the action pattern DB 23, action patterns of the participants at the event are stored. For example, in the action pattern DB 23, the action pattern may be provided for each weather, or the action pattern of the participant at the event defined from the distribution showing the deviation in departure time may be provided for each weather and each predicted weather for classifying by weather. The action pattern DB 23 will be described below with reference to FIG. 7.

The simulator 30 includes a traffic demand data generating unit 31 which generates traffic demand data (in this embodiment, an OD matrix is exemplified.) and a simulating unit 32 which calculates a traffic flow model based on the OD matrix. The traffic demand data generating unit 31 includes a new event traffic demand predicting unit 33 which predicts traffic demand relative to a new event online and an OD matrix correcting unit 34 which corrects a demand based on online traffic volume information.

The new event traffic demand predicting unit 33 receives new event information notified from the input apparatus 10, corrects the OD matrix (a go-to-event OD matrix, a return-from-event OD matrix, and the like) relative to a past event according to the new event information, the OD matrix being associated with the past event (similar event) similar to the new event in the past event DB 22, and outputs a new-event-considered OD matrix showing a total traffic demand including the increased demand at the time of the new event.

The OD matrix correcting unit 34 corrects the new-event-considered OD matrix output from the new event traffic demand predicting unit 33 based on the online traffic volume from the traffic volume information acquisition device 13 and outputs an OD matrix. At this time, the OD matrix correcting unit 34 corrects the new-event-considered OD matrix using well-known technique (for example, a micro-fluctuation OD correcting function described in JP-A-2003-272083).

The simulating unit 32 receives the OD matrix notified from the traffic demand data generating unit 31 and traffic regulation information on the new event transmitted from the event information acquisition device 11, and performs traffic flow simulation such as macro traffic flow-micro traffic flow cooperation based on road network information, thereby outputting a vehicle driving situation.

The output apparatus 40 receives the vehicle driving situation transmitted from the simulator 30 and performs analytical processing as necessary to output an analysis result. The output is presented for each predicted weather (for example, the analysis result is displayed in classification such as “case of sunny”, “case of rainy”, “case of snowy”, and the like). In addition, when unpredictability information is received from a retrieving unit 331 to be described, the output apparatus 40 displays notification such as “prediction on a traffic volume in this event site is not available at present”. During the analytical processing, the traffic volume of several road points, the temporal change of predicted values related to an itinerary time, and the like are analyzed.

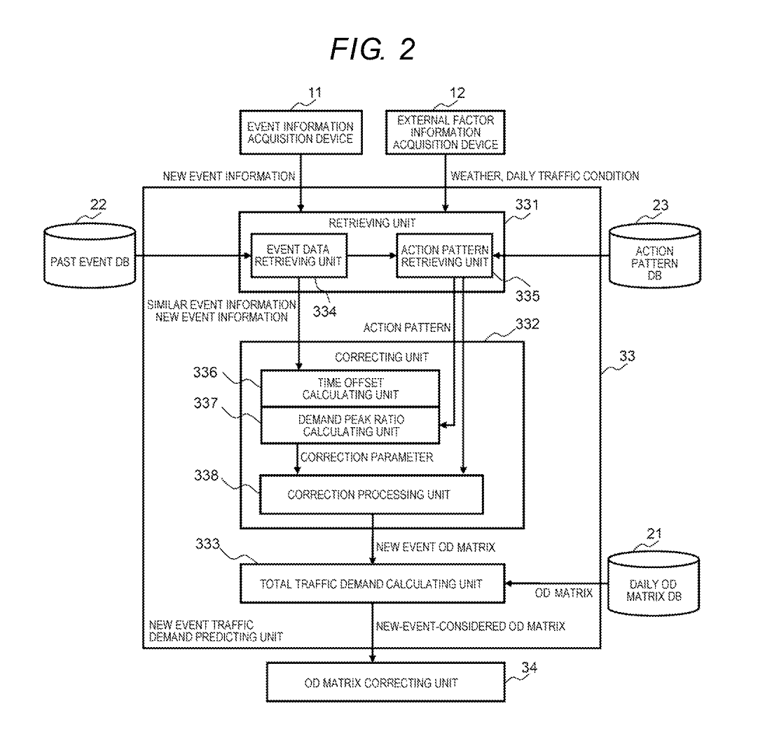

FIG. 2 is a diagram illustrating a configuration example of the new event traffic demand predicting unit 33.

The new event traffic demand predicting unit 33 includes the retrieving unit 331 which retrieves a similar event and an action pattern, a correcting unit 332 which predicts an OD matrix of a new event, and a total traffic demand calculating unit 333 which adds the OD matrix of the new event to a daily OD matrix.

The retrieving unit 331 retrieves, for example, a past event of a site coinciding with the site of the new event as a similar event from the past event DB 22. For example, the retrieving unit 331 retrieves an action pattern corresponding to the weather of the retrieved similar event from the action pattern DB 23. Further, the retrieving unit 331 retrieves an action pattern corresponding to the weather of the retrieved similar event from the action pattern DB 23 for each predicted weather.

More specifically, the retrieving unit 331 includes an event data retrieving unit 334 which selects a similar event in the past event DB 22 based on the new event information to retrieve event traffic demand relative to the similar event, and an action pattern retrieving unit 335 which retrieves an action pattern in the action pattern DB 23 from the new event information and the similar event information.

The event data retrieving unit 334 selects a similar event for minimizing an error function from the past event DB 22 based on the new event information from the event information acquisition device 11 to output traffic demand data associated with the similar event. More specifically, when there are a plurality of past events at the site coinciding with the site of the new event, the event data retrieving unit 334 retrieves a past event having the highest similarity to the new event as a similar event, based on one or a plurality of pieces of information among the type of the new event, the number of participants of the new event, the starting time of the new event, and the ending time of the new event, and one or a plurality of pieces of information among the type of the past event, the number of participants of the past event, the starting time of the past event, and the ending time of the past event, and outputs event traffic demand of the similar event.

The action pattern retrieving unit 335 receives an input of the weather of the similar event notified from the event data retrieving unit 334 and extracts an action pattern associated with a standard weather coinciding with the received weather from the action pattern DB 23 for each predicted weather to be output.

The correcting unit 332 reflects the differences between the similar event and the new event to the traffic demand data of the similar event. More specifically, the correcting unit 332 includes a time offset calculating unit 336 which outputs a correction parameter relating to a time, a demand peak ratio calculating unit 337 which outputs a correction parameter relative to a demand peak ratio, and a correction processing unit 338 processes the OD matrix of the similar event using the correction parameter.

The time offset calculating unit 336 calculates, for example, when the starting time of the new event does not coincide with the starting time of the similar event, the time difference for correcting the traffic demand data of the similar event, and calculates the time difference for correcting the traffic demand data of the similar event when the ending time of the new event does not coincide with the ending time of the similar event.

For example, when the number of participants at the new event is different from the number of participants at the similar event, the demand peak ratio calculating unit 337 calculates a ratio of number of participants for correcting the traffic demand data of the similar event based on the number of participants at the new event and the number of participants at the similar event.

The correction processing unit 338 corrects the traffic demand data of the similar event with classification by the predicted weather based on the distribution showing the deviation in departure time of the action pattern corresponding to the weather of the similar event, for example. Further, the correction processing unit 338 corrects the traffic demand data of the similar event using the correction parameter relating to a time and/or the correction parameter relative to a demand peak ratio, for example.

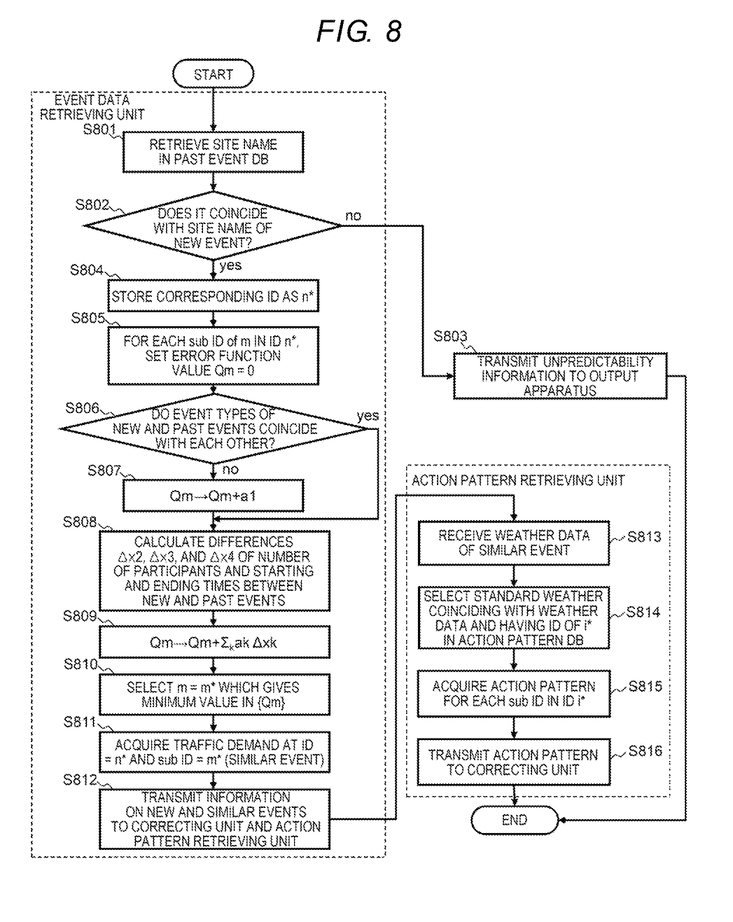

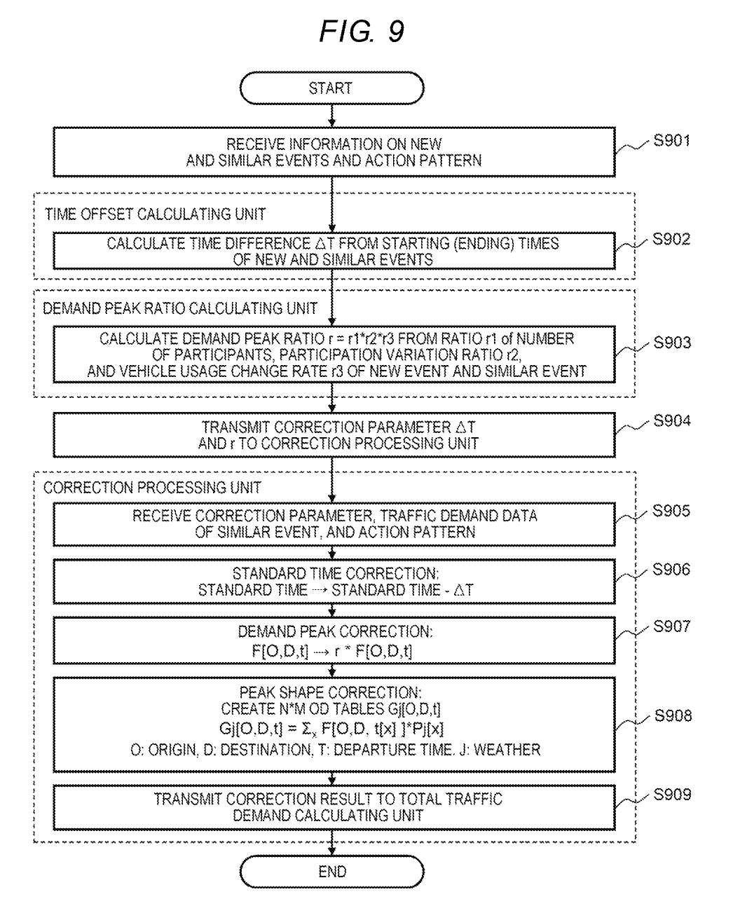

The processing by the retrieving unit 331 will be described with reference to FIG. 8. Also, the processing by the correcting unit 332 will be described with reference to FIG. 9.

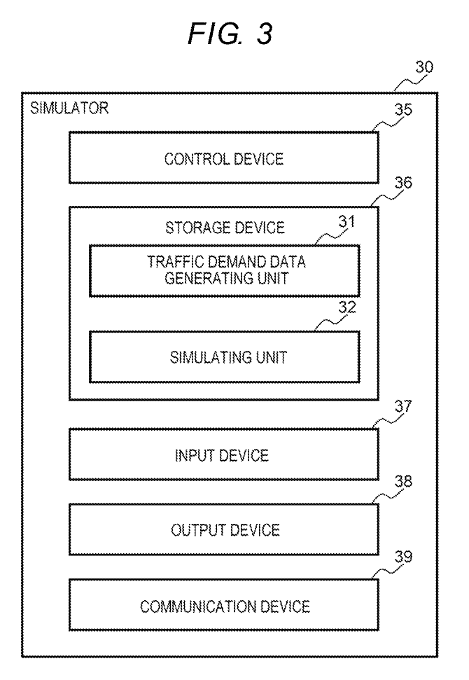

FIG. 3 is a diagram illustrating an example of hardware resources of the simulator 30.

The simulator 30 is, for example, a computing device (computer) such as a laptop computer, a server device, or the like, and includes, a control device 35, a storage device 36, an input device 37, an output device 38, and a communication device 39.

The control device 35 is, for example, a central processing unit (CPU), and executes various kinds of processes. The storage device 36 is a random access memory (RAM), a read only memory (ROM), a hard disk drive (HDD), or the like, and stores various kinds of information. The function of the simulator 30 (the traffic demand data generating unit 31, the simulating unit 32, or the like) may be, for example, implemented such that the CPU reads out a program stored in the ROM to the RAM to be executed (software), may be implemented by hardware such as a dedicated circuit, or may be implemented by a combination of software and hardware. In addition, part of the function of the simulator 30 may be implemented by another computer which is communicable with the simulator 30.

The input device 37 is a pointing device, a keyboard, or the like, and inputs various kinds of information in response to an operation by a user. The output device 38 is, for example, a display or the like, and displays various kinds of information. The input device 37 and the output device 38 may be integrally provided such as a display including a touch panel, or the like. In addition, the input device 37 and/or the output device 38 may not be necessarily provided, for example. The communication device 39 includes, for example, a network interface card (NIC), and performs protocol control during communication with the input apparatus 10 or the like.

FIG. 4 is a diagram illustrating an example of new event information. The new event information includes information such as a site name 401, an event type 402, the number of participants 403, a starting time 404, an ending time 405, and the like. The new event information is input (registered) by a user or the like of the event information acquisition device 11.

The site name 401 indicates the name of the site where a new event is to be held. The event type 402 indicates the type of the new event (a concert, sport competitions, a festival, or the like). The number of participants 403 indicates the number of people who participate in the new event. The starting time 404 indicates the starting time of the new event. The ending time 405 indicates the ending time of the new event. An ID (an identifier for identifying the site) may be assigned in the new event information at an appropriate timing, using the site name 401, the address, the telephone number, and the like not illustrated as a key.

FIG. 5 is a diagram illustrating an example of a data structure of the past event DB 22. The past event DB 22 includes a past event information table 500 which contains information on a past event, a past event traffic demand table 510 which contains information on traffic demand data of a past event, and a past event retrieving parameter table 520 which contains parameters used for retrieving a past event.

In the past event information table 500, information such as an ID 501, a site name 502, a sub ID 503, an event type 504, the number of participants 505, a starting time 506, an ending time 507, the weather 508, and the like are stored to be associated one another as past event information.

The ID 501 indicates an identifier for identifying the site where the past event was held. The site name 502 indicates the name of the site where the past event was held. The sub ID 503 indicates an identifier for identifying each event to be held in one site. The event type 504 indicates the type of the past event (a concert, sport competitions, a festival, or the like). The number of participants 505 indicates the number of people who participated in the past event. The starting time 506 indicates the starting time of the past event. The ending time 507 indicates the ending time of the past event. The weather 508 indicates the weather (sunny, rainy, snowy, or the like) when the past event was held.

In the past event traffic demand table 510, information such as an ID 511, an origin list 512, a destination list 513, a parking lot list 514, a sub ID 515, a go-to-event OD matrix 516, a return-from-event OD matrix 517, and the like are stored to be associated with one another.

The ID 511 indicates an identifier for identifying the site where the past event was held. The origin list 512 indicates a list (set) of origins of movement when the participants in a past event went to the event. The origin of movement is assigned in classification by prefecture, by municipality, by district, or the like. In this example, a list is provided in units of city. The destination list 513 is a list (set) of destinations of movement when the participants in a past event returned from the event. The destination of movement is similar to the origin of movement, and is provided with a list in units of city in this example. The parking lot list 514 indicates a list of one or a plurality of parking lots used by the participants going to the site of the past event.

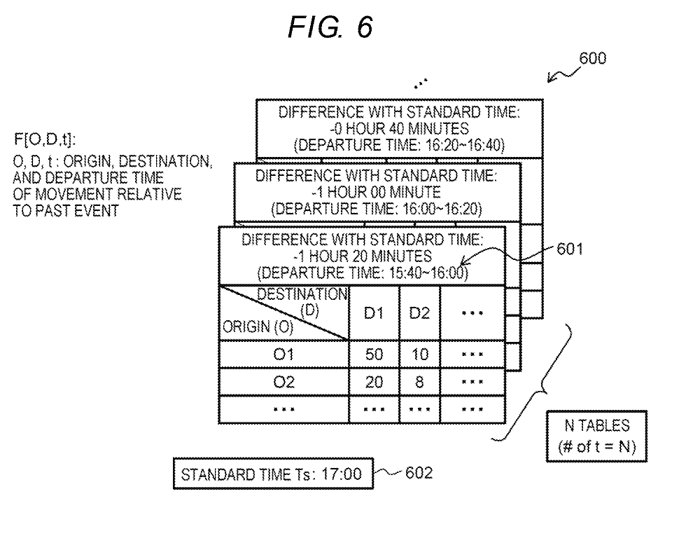

The sub ID 515 indicates an identifier for identifying each event held in one site. The go-to-event OD matrix 516 is a table obtained by collecting OD matrixes derived from the event by each departure time zone when the participants went to the past event. The return-from-event OD matrix 517 is a table obtained by collecting OD matrixes derived from the event by each departure time zone when the participants returned from the past event. In the following description, when the go-to-event OD matrix 516 and the return-from-event OD matrix 517 do not need to be distinguished, the matrixes are appropriately referred to an OD matrix relating to the past event. The OD matrix relating to the past event will be described with reference to FIG. 6 below.

The past event retrieving parameter table 520 stores information for defining parameters (weights) of items when retrieving a similar event. In the past event retrieving parameter table 520, information on a coefficient name and a coefficient (value) is stored for the item relating to the past event.

In the past event retrieving parameter table 520, the coefficient name “www” and the coefficient “a1” are registered for a parameter 521 relating to the event type, the coefficient name “xxx” and the coefficient “a2” are registered for a parameter 522 relating to the number of participants, the coefficient name “yyy” and the coefficient “a3” are registered for a parameter 523 relating to the starting time, and the coefficient name “zzz” and the coefficient “a4” are registered for a parameter 524 relating to the ending time, by a system manager or the like.

FIG. 6 is a diagram illustrating an example of the OD matrix relating to the past event. As illustrated in FIG. 6, in OD matrixes 600, the number of vehicles going to the event or the number of vehicles returning from the event is handled in a table format in association with the origin (O) and the destination (D) for each departure time 601 of the movement.

The departure time 601 is given, for example, by the difference from the standard time Ts 602. The standard time Ts 602 is given, for example, by the starting time 506 of the past event. Accordingly, the OD matrix 600 is represented by, for example, a set of N tables in which the number of vehicles is collected at a fixed time interval Δt with respect to the departure time 601. As illustrated in FIG. 6, Δt is 20 minutes in this example.

Since the OD matrix relating to the past event has the above-described data structure, it is possible to specify the number of vehicles by specifying the origin (O), the destination (D), and the departure time (t) (F[O, D, t]). Here, “t” is a departure time, and corresponds to the difference from the standard time Ts in this example.

FIG. 7 is a diagram illustrating an example of a data structure of the action pattern DB 23. The action pattern DB 23 includes a predicted action pattern table 700.

The predicted action pattern table 700 stores information such as an ID 701, a standard weather 702, a sub ID 703, a predicted weather 704, an action pattern 710, and the like to be associated one another.

The ID 701 indicates an identifier for identifying the weather. The standard weather 702 indicates the weather (sunny, rainy, snowy, or the like). The sub ID 703 indicates an identifier for identifying the predicted weather 704. The predicted weather 704 indicates the weather to be analyzed (simulated). The predicted action pattern table 700 is provided with the predicted weather 704 for each standard weather 702, and is provided with the action pattern 710 for each predicted weather 704.

The action pattern 710 is stored to be associated with information such as a participation variation ratio 711, a vehicle usage change rate 712, departure time deviation distribution 713 (Pj[x]), and the like. The action pattern 710 is created, for example, based on survey data such as literature, accumulated knowledge, and the like.

The participation variation ratio 711 is calculated, for example, from the number of participants when the weather is changed in between the standard weather 702 and the predicted weather 704/the number of participants when the weather is not changed in therebetween. The vehicle usage change rate 712 is calculated, for example, from the vehicle usage rate of participants when the weather is changed in between the standard weather 702 and the predicted weather 704/the vehicle usage rate of participants when the weather is not changed in therebetween. The vehicle usage change rate 712 may be calculated, for example, from the number of vehicles used of participants when the weather is changed in between the standard weather 702 and the predicted weather 704/the number of vehicles used of participants when the weather is not changed in therebetween.

The departure time deviation distribution 713 contains, for example, a value (for example, the proportion of the number of vehicles corresponding to each deviated time) for calculating the number of vehicles for each deviated time (x) of the departure time. The departure time deviation distribution 713 is segmented by M time zones. Here, it is desirable to handle the deviated time and the departure time of the OD matrix with the same time zone width Δt. For adjusting the time zone width, it is possible to use a complementary method of a point-sequence of Pj[x], for example.

Further, the candidate for the item of the standard weather 702 and the predicted weather 704 is desirably set to be coincident with the candidate for the item of the weather 508 in the past event DB 22. In the embodiment, the description will be made such that all the weather data (information of the weather 508, the standard weather 702, and the predicted weather 704) is selected from the same candidate.

FIG. 8 is a diagram illustrating an example of a flowchart of retrieving processing executed by the retrieving unit 331.

First, the event data retrieving unit 334 acquires new event information from the event information acquisition device 11 to retrieve a site name 502 in the past event DB 22 which coincides with a site name 401 of the new event information (step S801). Also, the event data retrieving unit 334 acquires coefficients (a1, a2, a3, and a4) from the past event retrieving parameter table 520 in the past event DB 22.

The event data retrieving unit 334 determines whether there is a site name 502 in the past event DB 22 coinciding with the site name 401 of the new event information (step S802). The process proceeds to step S804 when the event data retrieving unit 334 determines that there is a site name 502 coinciding with the site name 401, and the process proceeds to step S803 of or returns when determining that there is no site name 502 coinciding with the site name 401.

In step S803, it is regarded that there is no past data coinciding with the site where the new event is held in the past event DB 22, so that the traffic demand is regarded unpredictable in this embodiment, and the retrieving unit 331 transmits unpredictability information to the output apparatus 40, thereby ending the retrieving processing.

In step S804, the event data retrieving unit 334 stores an ID 501 associated with the corresponding site name 502 as n*.

Subsequently, the event data retrieving unit 334 acquires information of the event type 504, the number of participants 505, the starting time 506, and the ending time 507 for each sub ID 503 from the ID n* in the past event DB 22 and sets an error function Qm to “0” (initial setting) (step S805).

Then, the event data retrieving unit 334 determines whether the event type 402 of the new event and the event type 504 of the past event coincide with each other for each sub ID 503 (step S806). The process proceeds to step S808 when the event data retrieving unit 334 determines that both event types coincide with each other, and the process proceeds to step S807 when determining that both event types do not coincide with each other.

In step S807, the event data retrieving unit 334 replaces Qm with Qm+a1.

In step S808, the event data retrieving unit 334 calculates a difference Δx2 between the number of participants 403 of the new event and the number of participants 505 of the past event, a difference Δx3 between the starting time 404 of the new event and the starting time 506 of the past event, and a difference Δx4 between the ending time 405 of the new event and the ending time 507 of the past event.

Then, the event data retrieving unit 334 calculates the error function Qm using Expression 1 (step S809).

Qm→Qm+Σₖak*Δxk [Expression 1]

Here, the sum k takes the whole subscripts of coefficients (a2, a3, . . . ). In the embodiment, “2”, “3”, or “4” is taken as k of Expression 1.

Subsequently, the event data retrieving unit 334 selects and stores a sub ID 503 which gives a minimum value in the set {Qm} of the error function calculated for each sub ID 503 as m* (step S810).

As described above, since the event data retrieving unit 334 retrieves the past event most similar to the new event as a similar event, it is possible to predict the traffic demand when the new event occurs more accurately in the traffic demand prediction system 1.

Then, the event data retrieving unit 334 selects a past event of which the ID 501 is n* and the sub ID 503 is m* as a similar event and acquires event traffic demand (a go-to-event OD matrix 516, a return-from-event OD matrix 517, and the like) associated with the similar event (step S811).

Subsequently, the event data retrieving unit 334 transmits the new event information and the similar event information (the event traffic demand of the acquired similar event) to the correcting unit 332 and transmits data (weather data) of the weather 508 of the similar event to the action pattern retrieving unit 335 (step S812).

Next, the action pattern retrieving unit 335 receives weather data of the similar event (step S813).

Subsequently, the action pattern retrieving unit 335 selects a standard weather 702 in the action pattern DB 23 which coincides with the received weather data and stores the ID 701 associated thereto as i* (step S814).

The action pattern retrieving unit 335 acquires an action pattern 710 for each sub ID 703 (for each predicted weather 704) of an ID 701 i* in the action pattern DB 23 (step S815).

The action pattern retrieving unit 335 transmits the acquired action pattern 710 to the correcting unit 332 (step S816), thereby ending the retrieving processing.

FIG. 9 is a diagram illustrating an example of a flowchart of correction processing executed by the correcting unit 332.

The correcting unit 332 receives new event information and similar event information from the event data retrieving unit 334 and receives an action pattern from the action pattern retrieving unit 335 (step S901).

Subsequently, the time offset calculating unit 336 acquires a time Tn (the starting time 404 and the ending time 405) of the new event information and a time Tp (the starting time 506 and the ending time 507) of the similar event information and calculates a time difference ΔT for each of the starting time and the ending time using Expression 2 (step S902).

ΔT=Tn−Tp [Expression 2]

The demand peak ratio calculating unit 337 acquires the number of participants 403 (Nn) of the new event information and the number of participants 505 (Np) of the similar event information and acquires a participation variation ratio 711 (r2) and a vehicle usage change rate 712 (r3) from the action pattern 710. Based on these pieces of information, a demand peak ratio r of the new event and the similar event is calculated using Expression 3 (step S903).

r=r1*r2*r3 [Expression 3]

Here, r1 is a ratio of number of participants Nn/Np of the new event and the similar event.

The correcting unit 332 transmits correction parameters (the time difference ΔT and the demand peak ratio r) to the correction processing unit 338 (step S904).

Subsequently, the correction processing unit 338 receives the correction parameters (the time difference ΔT and the demand peak ratio r), the traffic demand data (OD matrix) of the similar event, and the action pattern 710 (step S905).

The correction processing unit 338 performs correction on the standard time Ts due to the time offset using Expression 4 (step S906).

Ts→Ts−ΔT [Expression 4]

For the standard time Ts relative to the go-to-event OD matrix 516, the time difference ΔT of the starting time is used, and for the standard time Ts relative to the return-from-event OD matrix 517, the time difference ΔT of the ending time is used.

As described above, since the standard time of each of the new event and the similar event is matched to correct the traffic demand data in the correction processing unit 338, it is possible to predict traffic demand when the new event occurs more accurately in the traffic demand prediction system 1.

The correction processing unit 338 performs correction on the traffic demand data according to the demand peak ratio r using Expression 5 (step S907).

F[O,D,t]→r*F[O,D,t] [Expression 5]

As described above, since the difference in the number of participants between the new event and the similar event is added to correct the traffic demand data in the correction processing unit 338, it is possible to predict the traffic demand when the new event occurs more accurately in the traffic demand prediction system 1. Also, since changes in participation due to the weather and changes in vehicle usage due to the weather are added to correct the traffic demand data in the correction processing unit 338, it is possible to predict the traffic demand when the new event occurs more accurately in the traffic demand prediction system 1.

Subsequently, the correction processing unit 338 calculates an OD matrix Gj[O, D, t] of the new event for each predicted weather 704 from F[O, D, t] representing the time distribution of each OD matrix of the event traffic demand of the similar event using Expression 6 (step S908).

Gj[O,D,t]=ΣₓF[O,D,t[x]]Pj[x] [Expression 6]

Here, “O” denotes an element of the origin list, “D” denotes an element the destination list, “j” denotes an index of the predicted weather 704, “x” denotes an index of the deviated time, t[x] denotes a departure time due to the departure time deviation, and F[O, D, t[x]] and Gj[O, D, t] denote information on the number of OD matrixes.

t[x] is represented by Expression 7, for example.

t[x]=t+Δt*x [Expression 7]

Here, Δt is a time interval of the departure time of the OD matrix.

As described above, since the deviation in departure time due to the weather is added to correct the traffic demand data in the correction processing unit 338, it is possible to predict the traffic demand when the new event occurs more accurately in the traffic demand prediction system 1.

Next, the correcting unit 332 transmits the correction result (new event OD matrix Gj[O, D, t]) to the total traffic demand calculating unit 333 (step S909), thereby ending the correction processing.

The total traffic demand calculating unit 333 which received the new event OD matrix Gj[O, D, t] extracts a daily OD matrix from the daily OD matrix DB 21 for each predicted weather 704 represented by j, adds the new event OD matrix Gj[O, D, t] to the daily OD matrix, and outputs a new-event-considered OD matrix. The new-event-considered OD matrix is obtained by adding the daily OD matrix to the OD matrix (traffic demand data) derived from the new event.

Accordingly, it is possible to quantitatively give the traffic demand data of the new event.

According to this embodiment, since the OD matrix associated with the similar event is corrected according to the new event information, it is possible to predict the traffic demand when the new event occurs.

### (2) Another Embodiment

In the above-described embodiment, the case where the invention is applied to the traffic demand prediction system 1 with respect to vehicles is described, but the invention is not limited thereto and can be widely applied to a various other systems, devices, and methods such as a movement demand prediction system for people.

In the above-described embodiment, the case where the DB group 20 is provided outside the simulator 30 was described, but the invention is not limited thereto and may include the DB group 20 provided inside (for example, in the storage device 36) the simulator 30.

In the above-described embodiment, the case where the vehicle driving situation, the unpredictability information, and the like are output from the output apparatus 40 was described, but the invention is not limited thereto, and the vehicle driving situation, the unpredictability information, and the like may be output from the output device 38 of the simulator 30.

In the above-described embodiment, the case was described where the site name 502 in the past event DB 22 which coincides with the site name 401 of the new event information is retrieved, but the invention is not limited thereto, and the site name may be retrieved using information with which the site can be identified (such as an identifier capable of identifying the site, the address of the site and the telephone number of the site (not illustrated)).

In the above-described embodiment, the case was described where the demand peak ratio (r) is calculated using all of the ratio of number of participants (r1), the participation variation ratio 711 (r2), and the vehicle usage change rate 712 (r3) between the new event and the similar event, but the invention is not limited thereto, and as r, any one of r1, r2, and r3 may be used or any combination of two of r1, r2, and r3 may be used.

In the above-described embodiment, the case was described where the OD matrix is generated with respect to the predicted weather, but the invention is not limited thereto, and it may only generate OD matrix of the predicted weather corresponding to the weather forecast of the new event.

In the above-described embodiment, for convenience of explanation, various types of data were described using the terms of XX data base and XX table, but the data structure is not limited thereto, and it may be expressed in terms of XX information, and the like.

In the above description, information on a program, a table, a file, or the like that realizes each function can be stored in a storage device such as a memory, a hard disk, a solid state drive (SSD) and the like, or a recording medium such as an IC card, an SD card, a DVD, and the like.

The above-described configuration may be changed, rearranged, combined, or omitted as appropriate without departing from the gist of the present invention.

What is claimed is:

1. A traffic demand prediction system for predicting traffic demand when a new event as a prediction target event occurs, the system comprising:
a past event database including information indicating a site of a past event which is an event held in the past and traffic demand data of the past event;
a retrieving unit retrieving a past event held in a site coinciding with a site of the new event from the past event data base as a similar event; and
a correcting unit reflecting the difference between the similar event retrieved by the retrieving unit and the new event to traffic demand data of the similar event.

2. The traffic demand prediction system according to claim 1, wherein
the past event data base stores one or a plurality of pieces of information among the type of a past event, the number of participants of a past event, the starting time of a past event, and the ending time of a past event, and
when there are plural past events held in a site coinciding with a site of the new event, the retrieving unit retrieves a past event having the highest similarity to the new event as a similar event based on one or a plurality of pieces of information among the type of the new event, the number of participants of the new event, the starting time of the new event, and the ending time of the new event, and one or a plurality of pieces of information among the type of a past event, the number of participants of a past event, the starting time of a past event, and the ending time of a past event.

3. The traffic demand prediction system according to claim 1, further comprising:
an action pattern data base storing an action pattern of a participant of an event for each weather, wherein
the retrieving unit retrieves an action pattern corresponding to the weather of the retrieved similar event from the action pattern data base.

4. The traffic demand prediction system according to claim 1, wherein
when the starting time of the new event does not coincide with the starting time of the similar event retrieved by the retrieving unit, the correcting unit calculates a time difference used for correcting traffic demand data of the similar event, and when the ending time of the new event dose not coincide with the ending time of the similar event the correcting unit calculates a time difference used for correcting traffic demand data of the similar event.

5. The traffic demand prediction system according to claim 1, wherein
when the number of participants at the new event differs from the number of participants at the similar event retrieved by the retrieving unit, the correcting unit calculates a ratio of number of participants used for correcting traffic demand data of the similar event, based on the number of participants at the new event and the number of participants at the similar event.

6. The traffic demand prediction system according to claim 1, further comprising:
an action pattern data base storing action patterns of participants at an event defined by distribution showing deviation in departure time, for each weather and for each predicted weather used for classification by weather, wherein
the retrieving unit retrieves an action pattern corresponding to the weather of the retrieved similar event for the predicted weather from the action pattern data base, and
the correcting unit corrects traffic demand data of the similar event with classification by the predicted weather based on the distribution showing deviation in departure time of the action pattern of the similar event retrieved by the retrieving unit.

7. A traffic demand prediction apparatus for predicting traffic demand when a new event as a prediction target event occurs, the apparatus comprising:
a past event data base including information indicating a site of a past event which is an event held in the past and traffic demand data of the past event;
a retrieving unit retrieving a past event held in a site coinciding with a site of the new event from the past event data base as a similar event; and
a correcting unit reflecting the difference between the similar event retrieved by the retrieving unit and the new event to traffic demand data of the similar event.
